(19) United States
(12) Patent Application Publication
(10) Pub. No.: US 2004/0070514 A1
(43) Pub. Date: Apr. 15, 2004

(54) Universal protocol converter

(76) Inventor: Michael E. Collier, Pembroke Pines, FL (US)

Correspondence Address: Robert S. Lipton, Esquire, LIPTON, WEINBERGER & HUSICK, 201 N. Jackson Street, P. O. Box 934, Media, PA, 19063, US

(21) Appl. No.: 10/418,188

(22) Filed: Dec. 17, 2003

Related U.S. Application Data
(60) Provisional application No. 60/373,118, filed on Apr. 17, 2002.

(51) Int. Cl. H04Q 1/00

(52) U.S. Cl. 340/825

(57) ABSTRACT

This invention relates to an apparatus and method for use in conjunction with cameras which are used to monitor motor vehicle traffic flow on highways, bridges and the like. The camera are mounted using servomotors which have made the cameras' direction to be varied by a remote operator. The invention permits cameras whose direction is driven by signals in different protocols for languages to be used in the same camera array.

### CROSS-REFERENCE TO RELATED APPLICATIONS

This application claims the benefit of U.S. Provisional Patent Application No. 60/373,118 filed Apr. 17, 2002 entitled Universal Protocol Converter (UPC).

### FIELD OF THE INVENTION

This invention in general relates to translating electronic protocols from one “language” to another and in particular data streams used to control mechanical objects such as remote sensors, motors or data.

### SUMMARY OF THE INVENTION

The invention is a computer-based system which controls the remote operation of cameras used in monitoring motor vehicle traffic on highways, bridges and the like, where cameras using different protocols for driving the motors which drive the cameras to be directed in a particular direction are used.

In the past, these problems have been solved by having a database where the first protocol or language is translated directly into the second language. This requires that the first language must be translated directly into a multiplicity of second languages.

### DESCRIPTION OF THE PRIOR ART

U.S. Pat. No. 6,271,752 to Chistof and Vaios describes a network of cameras and operators including method of translation.

### BRIEF DESCRIPTION OF THE DRAWINGS

The accompanying drawings, which are incorporated in and form a part of the specification, illustrate the embodiments of the present invention and, together with the description, serve to explain the principles of the invention. The drawings and their descriptions are set forth in the Description of the Invention.

### DESCRIPTION OF THE INVENTION

In describing an embodiment of the invention, specific terminology will be selected for the sake of clarity. However, the invention is not intended to be limited to the specific terms so selected, and it is to be understood that each specific term includes all technical equivalents that operate in a similar manner to accomplish a similar purpose.

The invention is a system which controls a mechanical device may transmit instructions to that device in a first language. However, the device which is being controlled may only respond to a second language. The particular device may be made by a variety of manufacturers, each of which uses a different language. The operator of the system desires to have the ability to use any one of a number of different manufacturers' devices and be able to use them interchangeably. This requires that the system be capable of automatically being able to translate the first language input signals into any one of a variety of different second languages (to A to B to C, etc.) which are being used by the particular device.

The recipient of the signal in the first language does not necessarily have to be a mechanical device. It may, as indicated above, be a data stream where the input data in the first language must be translated into a second language.

In the past, these problems have been solved by having a database where the first protocol or language is translated directly into the second language. This requires that the first language must be translated directly into a multiplicity of second languages.

The Universal Protocol Converter (UPC) is intended to resolve communication shortcomings and limitations between two heterogeneous devices. This is accomplished by converting an “input” protocol to an “output” protocol and inversely converting the “output” protocol to the “input” protocol. By using a Single Board Computer (SBC) that is loaded with a version of software that accepts an “input” protocol, via RS-232 or Ethernet communication, translating the “input” protocol to a generalizing “generic” protocol. It then translates the “generic” protocol to the “output” protocol and delivers it via RS-232, RS-422/RS-485, or Ethernet connection. The process is the same for converting from “input” to “output” protocols as well as converting “output” to “input” protocols.

Explanation:

The software is modular by design. This is necessary to accommodate the ease of programming for one distinct device to another distinct device.

The main modules consist of the following:

Input Module: This module is for accepting communications, via RS-232, from the input device, and translating to the “generic” protocol.

Output Module: This module is for accepting communications, via RS-232 or RS-422/RS-485, from the output device, and translating to the “generic” protocol.

Network Module: This module is for accepting and sending communications via Ethernet connection.

Utility Module: This module allows for various functionality that is necessary for the software program to perform correctly and interact with the hardware on the SBC.

The Input and Output modules are interchangeable and allow for the construction of various software versions based on the devices and protocols that will be used by the UPC.

Implementation:

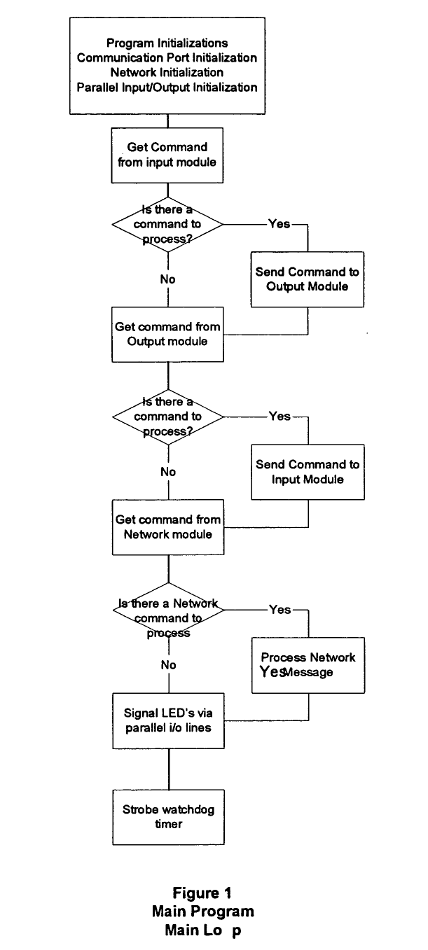

The main procedure is outlined in the FIG. 1 (main loop). The program first initializes hardware devices via the relevant module functions. It then enters a main (infinite) loop, which continually checks for messages from the “input” and “output” device, signaling Light Emitting Diodes (LEDs) and signaling a “watchdog” timer.

Utility Module:

The utility module contains the functionality for the software program to interact with the hardware devices located on the SBC. An example of the functions it contains follows:

InitPIO

GetId

ToggleLeds

SetLeds

SetCom1Leds

SetCom2Leds

SetEthLeds

InitWD

StobeWD

IntTimer

Network Module:

The network module contains the functionality for the program to interact with the network capabilities of the SBC. An example of the functions it contains follows:

InitNet

GetNetMessage

SendNetMessage

Input/Output Module:

The input/output modules contain the functionality for the program to translate protocols from one protocol to the “generic” protocol, translate the “generic” protocol to its native protocol, and to deiliver the communcations to the hardware device. Examples of the typical functions that they contain follow:

| Input | Output |
|---|---|
| _GetCommand | _GetCommand |
| _SendCommand | _InitCommPort |
| _InitCommPort | _SendCommand |
| _ExpiredCommand | _CalcCRC |
| _GetNextValidCommand | _AccumByteCRC |
| _CheckCommandExpiration | _AccumulateCRC |
| _CompareCommands | _ConvertCommand |
| _ShiftStructRight | _TranslateCommand |
| _SendString | _TranslateText |
| _TranslateCommand | _TranslateRequest |
| _CopyCommands | _SendString |
| _ShiftExpiredCommands | |

Due to the complexity of individual protocols, some functionality may be needed in one module that is not necessary in another module. Cyclic Redundancy Checks (CRC), for example, may be needed by one particular protocol, but not used for another.

The Execution:

Program execution begins immediately after power is supplied to the SBC and follows the outline from the main loop figure. A more detailed explanation follows:

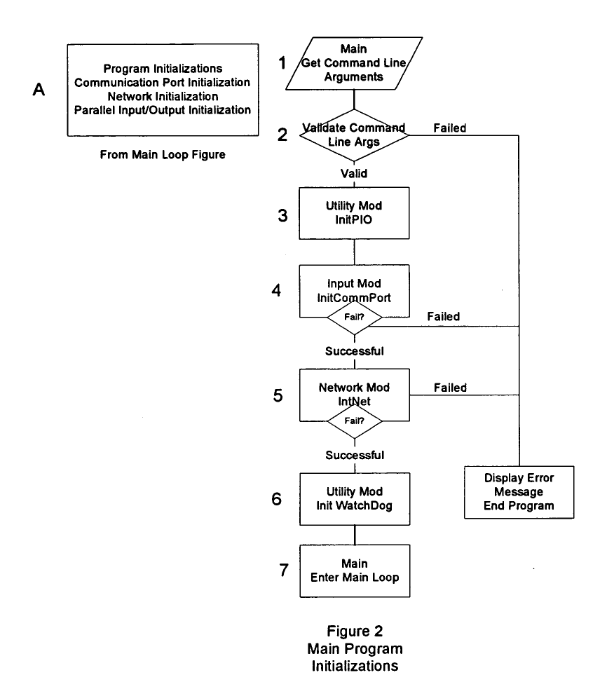

A. Program Initialization as set forth in FIG. 2.

1. Command Line Arguments are stored.

2. Command Line Arguments are verified.

If Command Line Arguments are invalid display error message and end program.

3. Initialize Parallel Input/Output lines.

Parallel I/O lines are used for LEDs and unit addressing.

Get current address setting from parallel I/O lines.

4. Initialize Input and Output Module corn port.

Use command line arguments to initialize the corn port settings.

Toggle LEDs to indicate initialization.

If initialization fails, display error message and end program.

5. Initialize Network Port.

Use command line arguments to initialize the corn port settings.

Toggle LEDs to indicate initialization.

If initialization fails, display error message and end program.

6. Initialize Watchdog Timer.

Initialize port settings on the SBC.

Re-vector interrupt 1C to an empty interrupt handler.

7. Enter Main Loop.

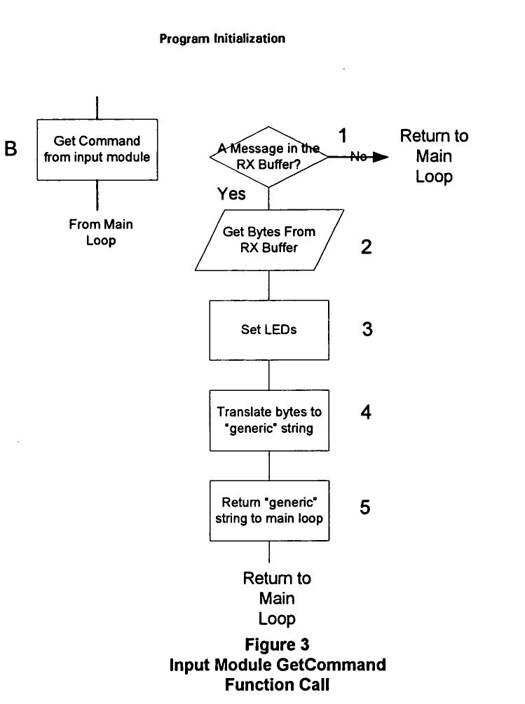

B. Main Loop: Input Message Retrieval as set forth in FIG. 3.

1. Check for input message.

Examine the contents of the serial port receive buffer.

If the buffer has enough stored bytes to process as a message, retrieve the bytes from the buffer. Otherwise, return to main loop.

In some cases, it may be necessary to complete other utilitarian functionality based on the nature of the protocol, such as removing expired commands, validating commands or synchronizing consecutive commands. For a more detailed description, see examples discussed later on.

2. Retrieve bytes from corn port receive buffer.

3. Set the appropriate LED flags.

The LED flags are used in the main loop by the utility

module to toggle the LEDs

on and off.

4. Translate bytes to “generic” string.

Each protocol uses various formats. Some use ASCII text

while others use

hexadecimal numbers to represent operations or messages. The

translation

process converts the input protocol to a generalizing “generic” protocol.

For

a more detailed description, see the examples that are discussed further on.

5. Return “generic” string to the Main Loop.

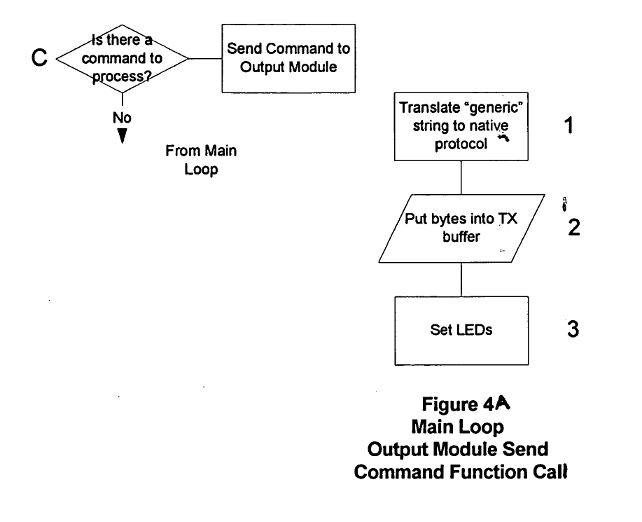

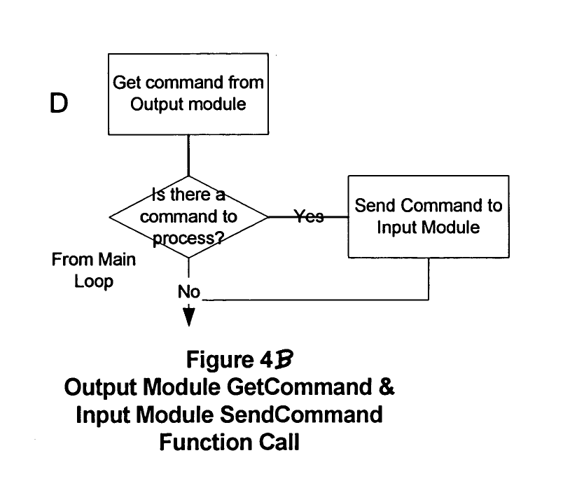

C. Main Loop: Input Message Handling as set forth in FIG. 4A.

If the return flag from the previous function call indicates that there is a Command to process, then send the command to the output module. Otherwise, continue on in the main loop.

1. Translate “generic” protocol to native protocol.

2. Put bytes into corn port TX buffer.

3. Set appropriate LED flags.

4. Return to main loop.

D. Main Loop: Output Module Message Retrieval and Handling as set forth in FIG. 4B.

The output module message routine mimics the input module message routine. For brevity, its description has been excluded. For a detailed description,

refer to the input module message description.

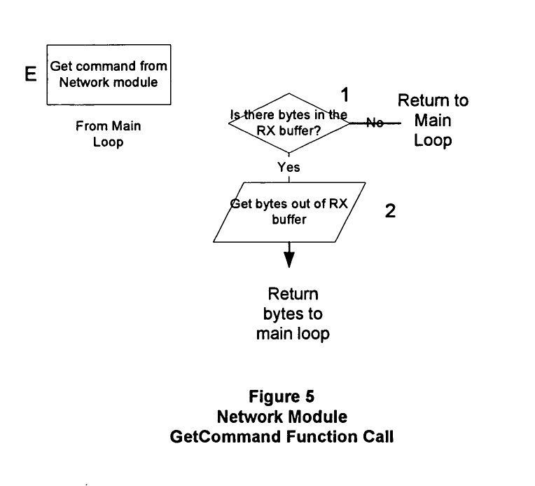

E. Main Loop: Network Message Retrieval as set forth FIG. 5.

1. Check the Ethernet RX buffer for bytes.

If there are no bytes in the RX buffer, then return to the main loop.

If there are bytes in the RX Buffer, continue with function call.

2. Get bytes from the RX buffer.

3. Return bytes to main loop.

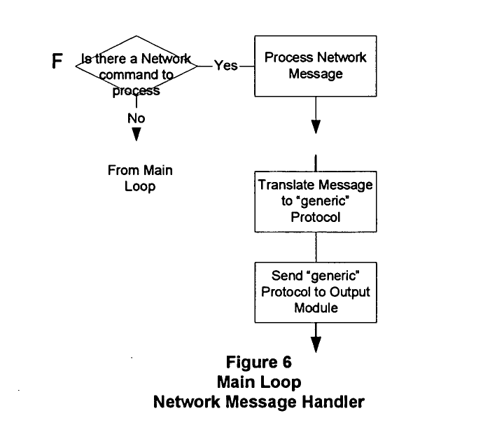

F. Main Loop: Network Message Handling as set forth in FIG. 6.

If the return flag from the previous function call indicates that there are no network messages to handle, then continue with main loop, otherwise complete the following steps.

1. Translate the network message into “generic” protocol

This is a function call to the input module.

2. Sent the resulting “generic” protocol the output module.

This function call will deliver the translated network message to the output device via the appropriate method (RS-232, RS-422/485, or Ethernet).

3. Continue with main loop.

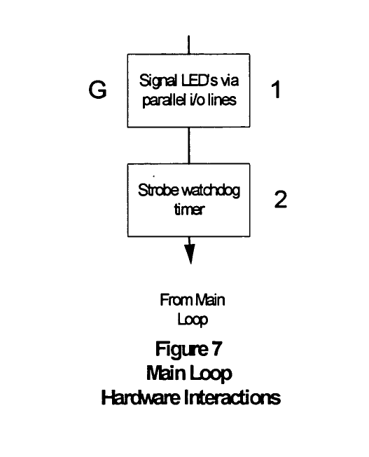

G. Main Loop: Hardware Interaction as set forth in FIG. 7.

1. Toggle LEDs.

By setting the LED flag appropriately, the LEDs can be turned on

or off by writing to the parallel input/output lines.

2. Strobe Watchdog Timer.

By writing to a particular port on the SBC, the Watchdog timer is flashed. If the watchdog timer is not flashed approximately every 1.6 seconds, the program terminates and restarts.

3. Continue with main loop by repeating procedures B-G.

Examples of Protocol Translation.

The following illustrates the typical dataflow used when converting from native protocol to the “generic Protocol.

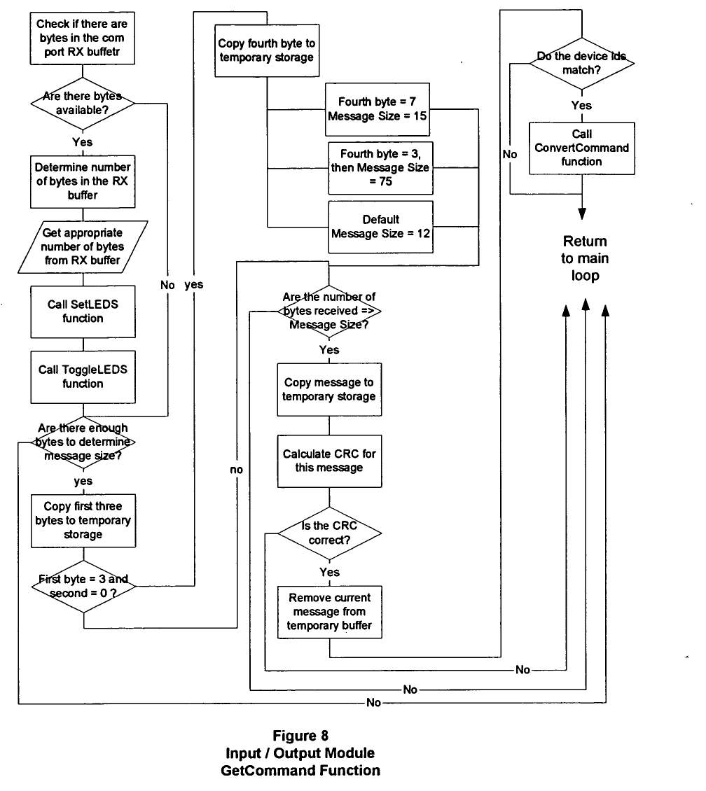

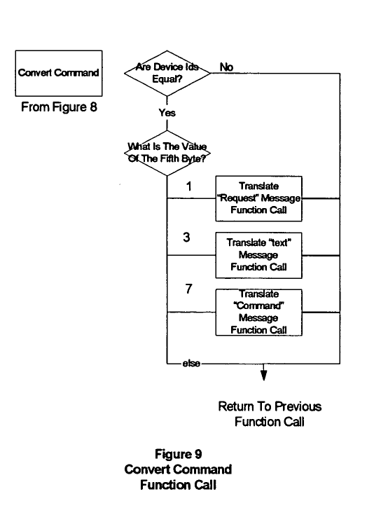

FIG. 8 shows how a particular routine is used to retrieve a communication from the serial corn ports. A brief explanation follows:

1. Check the receive buffer for available bytes.

If there are no bytes waiting in the receive buffer, proceed to step 7.

2. Determine the number of bytes available in the receive buffer and temporarily store that number.

3. Fetch the number of bytes indicated, from the previous step, from the serial device.

4. Store the bytes from the previous step in a temporary buffer.

The temporary buffer is a static memory allocation that remains unchanged from invocation to invocation of this particular function call.

5. Set the appropriate flags in the LEDflags structure via function call in Utility Module.

6. Call the ToggleLEDs function in the Utility Module.

This will toggle on, or off, the appropriate LEDs.

7. Check if there are enough bytes in the temporary buffer to determine Message Size.

This is protocol specific. The Message Size indicates the number of bytes that constitutes a valid command from the input/output device. The Message Size is a static memory allocation that is initialized on the very first invocation of the function call. If there are not enough bytes in the temporary buffer to determine the Message Size, return from this function call by indicating there are no messages to process. Otherwise, continue on to the next step.

8. Copy the first three bytes of the message to temporary storage.

9. Check if the first byte=3 and the second byte=0.

This is protocol specific. In this particular case, this indicates the beginning of a valid command from the input/output device, which in turn indicates that the fourth byte will determine the Message Size. If this test fails continue on to step 11

10. Check the value of the fourth byte that is stored in the temporary buffer.

This is protocol specific. This byte determines the valid Message Size.

Set the Message Size as indicated by the fourth byte.

11. Check if the number of bytes in the temporary buffer is equal to the Message Size.

If this test fails, return to the main loop indicating that there is no message to process, otherwise continue on to step 12.

12. Temporarily copy the number of bytes indicated by the Message Size out of the temporary buffer.

13. Calculate Cyclic Redundancy Check (CRC) on the temporary message via function call.

This is protocol specific.

14. Check if CRC is correct.

If CRC fails, return to main loop indicating there are no messages to process. Otherwise continue to the next step.

15. Remove this message from the temporary buffer.

16. Check if the device id in the message is equal to this device id.

If the ids do not match, then return to main loop indicating there are no messages to process. Otherwise continue to the next step

17. Convert message to the “generic” protocol via a function call to ConvertCommand.

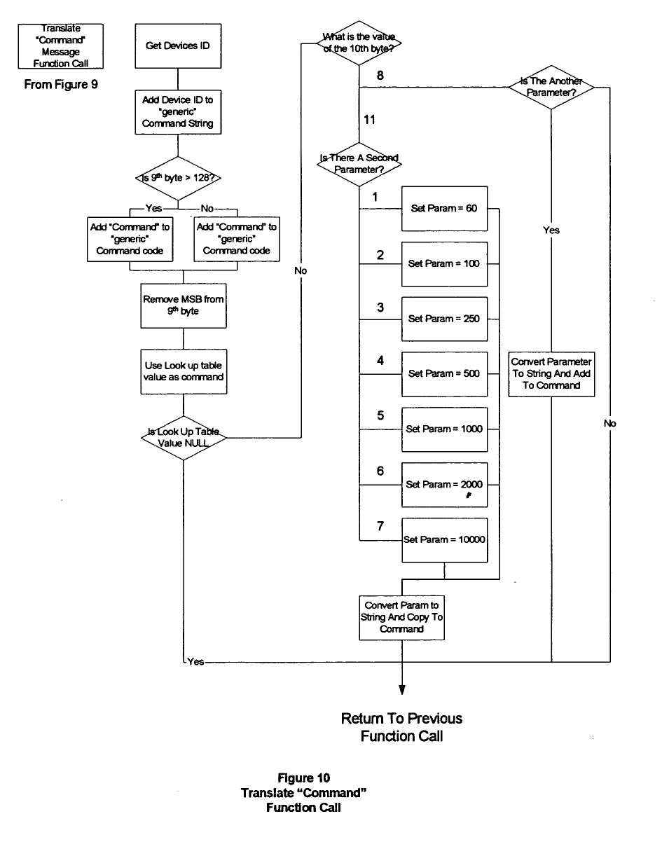

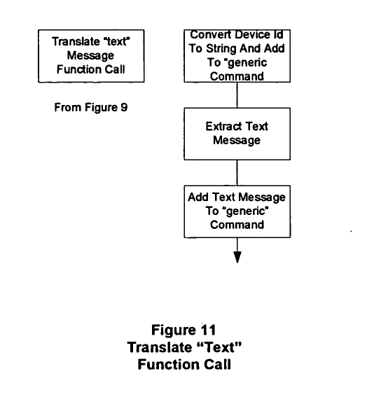

Convert Command Function Call as Set Forth in FIG. 9.

1. Compare the device ID with the message ID.

If the device Ids do not match, return to previous function call.

2. Determine value of 5^{th} byte of the message.

This is protocol specific.

If the value of the 5^{th} byte is equal to 1, make a “Request” message function call.

This indicates a request of information from the attached device.

It the value of the 5^{th} byte is equal to 3, make a “text” message function call.

This indicates a text message needs to be translated.

It the value of the 5^{th} is equal to 7, make a command message function call.

This indicates a command is issued to control the attached device.

3. Return to previous function call.

Translate a “Command” Message Function Call as Set Forth in FIG. 10.

1. Get the device ID.

2. Add the device to the translated “generic” command.

3. Is the 9^{th} byte of the input command >128.

This is protocol specific. The 9^{th} byte is a bitmapped

byte that indicates, among other aspects, if the command is a “test” message or “command” message.

In this case, the Most Significant Bit (MSB), the 8^{th} bit indicates the above condition. If the MSB is set, then the message is a “command” message, otherwise it is a

“test” message.

YES condition. The message is a “command” message, and “command” is appended to the translated command.

NO condition. The message is a “request” message, and “request” is appended to the translated command.

4. Remove the Most Significant Bit from the 9^{th} byte.

Once removed, the 9^{th} byte serves as an index into a look up table that hold the translated command.

5. Use the 9^{th} byte and look up table to translate message.

6. Is the result from the look up table empty (NULL)?

YES condition. Return to previous function call.

NO condition. Continue.

7. Determine value of the 10^{th} byte.

This is protocol specific.

Value is equal to 8. Continue to step 8.

Value is equal to 11. Continue to step 10.

8. Is there another parameter (11^{tth} byte)?

This is protocol specific.

YES condition. Continue to step 9

NO condition. Return to previous function call.

9. Append additional parameter to translated command.

Return to previous function call.

10. Is there another parameter (11^{tth} byte)?

This is protocol specific.

Set the value of the additional parameter as indicated in FIG. 10 based on the value (1-7) as indicated in FIG. 10.

11. Append the resulting parameter value to the translated command

12. Return to the previous function call.

Translate “Text” Message as Set Forth in FIG. 11.

1. Get device Id and append to translated command

2. Extract text message from “native” protocol.

This is protocol specific.

The text message consists of 3 text lines, each 21 characters long with the first

character of the first line beginning at byte 9.

3. Append resulting text to translated message.

4. Return to previous function call.

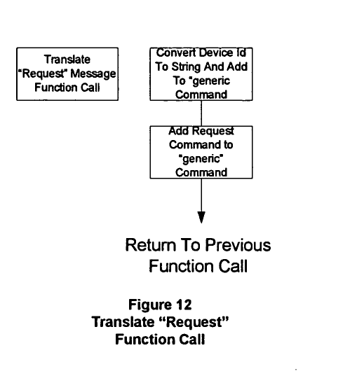

Translate Request Command as Set Forth in FIG. 12.

1. Get device ID and append to the translated command.

2. Append “request” to translated command.

This is protocol specific. In some instances, multiple commands may need to be

sent in order to fulfill the request command.

3. Return to previous function call.

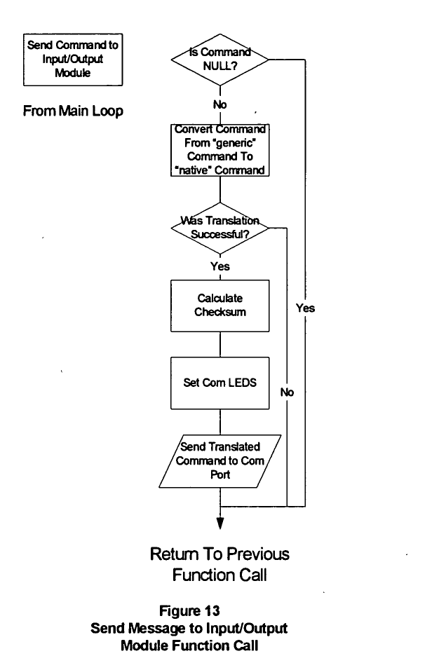

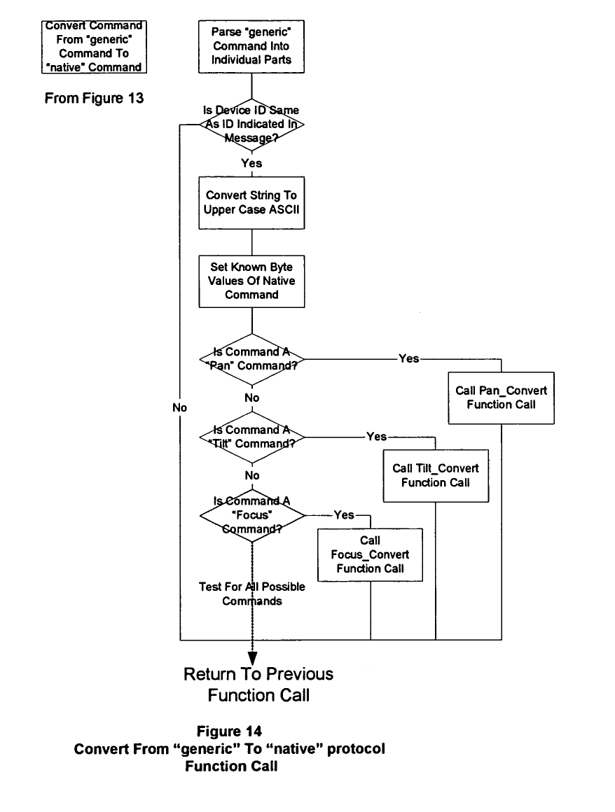

Send Command To Input/Output Module as Set Forth in FIG. 13.

1. Validate command.

If the command is empty (NULL), return to previous function call indicating no commands to translate.

2. Call ConvertCommand function call.

This function call converts the “generic” protocol to “native” protocol.

3. Was translation successful?

If above function call indicates an unsuccessful translation, return to previous function call indicating no command was translated.

4. Calculate checksum via function call.

This is protocol specific. This is a simple checksum calculation, the value of all the

bytes of the current “native” protocol are Exclusively Or-ed, and the Least Significant

byte is used.

5. Set corn port LEDs via function call.

6. Send translated command out appropriate corn port.

7. Return to previous function call.

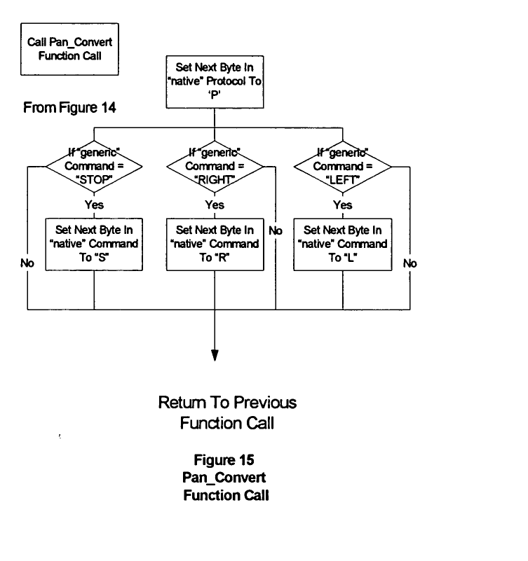

Convert Command Function Call as Set Forth in FIG. 14.

1. Parse “generic” command into individual parts.

The “generic” protocol is and ASCII based Pipe, “|”,

delineated string. See following examples for detailed explanation.

2. Is device ID equal to device ID in message?

YES condition. Continue.

NO condition. Return to previous function call.

3. Convert ASCII string to uppercase.

4. Set all known “native” bytes.

This is protocol specific.

5. Is this a “PAN” command?

YES condition. Make a PAN_Convertion function call.

NO condition. Continue until correct command is found.

6. Is this a “TILT” command?

YES condition. Make a TILT_Convertion function call.

NO condition. Continue until correct command is found.

7. Is this a “Focus Command?

YES condition. Make a FOCUS_Convertion function call.

NO condition. Continue until correct command is found.

8 . . . check for all possible commands.

If suitable command is found call appropriate function call, otherwise continue to next step.

9. Return to previous function.

Pan Command Conversion Function Call as Set Forth in FIG. 15.

1. Set the next byte in the native.

2. If “generic” command=“STOP”.

YES condition. Continue to next step

No condition. Continue to step 4

3. Set next byte in “native” command=“S”.

Set byte and return to previous function call.

4. If “generic” command=“RIGHT”.

YES condition. Continue to next step

No condition. Continue to step 4

5. Set next byte in “native” command=“R”.

Set byte and return to previous function call.

6. If “generic” command=“LEFT”.

YES condition. Continue to next step

No condition. Continue to step 4

7. Set next byte in “native” command=“L”.

Set byte and return to previous function call.

8. Return to previous function call.

Tilt Command Conversion Function Call, And Subsequent Conversion Function Calls.

All of the individual Conversion function calls closely mimic the previous Pan_Conversion function call. The only significant distinction is the individual characters that are used by the specific protocol. Therefore, the detailed explanation and flow chart diagrams are omitted for brevity.

Protocol Definitions.

The previous explanation, FIGS. 8-15, use the following protocols as example protocols.

Input protocol.

Input device—Pan/Tilt/Zoom Camera Controller.

Protocol Definition:

This protocol uses binary data to interpret which command is to be issued and is compromised or 15 bytes.

| Byte | Definition |
|---|---|
| 0 | Controller Address |
| 1 | Functional Device Type |
| 2 | Functional Device ID (high order byte) |
| 3 | Function Device ID (low Order byte) |
| 4 | Test \| Circuit Flag \| Com - Res p \| |
| | Message = 7 |
| 5 | Sequence Number |
| 6 | EOF\| Reserved |
| 7 | Byte Count = 15 (high order byte) |
| 8 | Byte Count (low order byte) |
| 9 | Command request\| Command code |
| 10 | Command Parameter 1 Value |
| 11 | Command Parameter 2 Value |
| 12 | Reserved |
| 13 | CRC (high order byte) |
| 14 | CRC (low order byte) |

The most relevant information required to complete the protocol conversion to or from the “generic” protocol is contained in bytes 9 through 11. The following excerpt shows the typical information stored in these bytes:

Command Code 1=TILT Motion Command

Parameter 1 Values:

0=Stop Tilt

1=Tilt Up, Normal Speed

2=Tilt Up, Fast Speed

3=Tilt Down, Normal Speed

4=Tilt Down, Fast Speed

Parameter 2 Values:

Not Used

Command Code 2=PAN motion command

Parameter 1 Values:

0=Stop Pan

1=Pan Left, Normal Speed

2=Pan Left, Fast Speed

3=Pan Right, Normal Speed

4=Pan Right, Fast Speed

Parameter 2 Values:

Not Used

Other Command Code Values Omitted for Brevity

Command Code 12=SHUTTER SPEED command

Parameter 1 Values:

0=Continue Current Setting

1=Automatic

2=Manual

Parameter 2 Values:

0=Not Used

1=1/60

2=1/100

3=1/250

4=1/500

5=1/1000

6=1/2000

7=1/10000

Output protocol.

Input device—Pan/Tilt/Zoom Camera.

Protocol Definition:

This protocol used several bytes of mixed modes, binary and ASCII data, to control the device. The format is specified as follows:

| Byte | Data | Description |
|---|---|---|
| 0 | F8 (hex) | Start Of Message |
| 1 | Address | 01 - DF (hex) |
| 2 | ‘c’ | Message Type |
| 3 to n + 3 | Command Data | Control Command |
| n + 4 | Checksum | End Of Message, LS nibble of all bytes |
| | | XORd |

The following is an excerpt of the Command Data from the output protocol:

| | |
|---|---|
| ‘PR’ | Pan Right |
| ‘PL’ | Pan Left |
| ‘PS’ | Pan Stop |
| ‘TU’ | Tilt Up |
| ‘TD’ | Tilt Down |
| ‘TS’ | Tilt Stop |
| ‘ZI’ | Zoom In |
| ‘ZO’ | Zoom Out |
| ‘ZS’ | Zoom Stop |
| ‘IO’ | Iris Open |
| ‘IC’ | Iris Close |
| ‘IS’ | Iris Stop |
| ‘S’ # | Shutter Speed |
| | # indicates: |
| | = 30 (hex) (1/4) |
| | = 31 (hex) (1/8) |
| | = 32 (hex) (1/15) |
| | = 33 (hex) (1/30) |
| | = 34 (hex) (Auto) |
| | = 35 (hex) (1/60) |
| | = 36 (hex) (1/100) |
| | = 37 (hex) (1/250) |
| | = 38 (hex) (1/500) |
| | = 39 (hex) (1/1000) |
| | = 3A (hex) (1/2000) |
| | = 3B (hex) (1/4000) |
| | = 3C (hex) (1/10000) |

Generalizing “Generic” Protocol

In both “native” to “generic” and “generic” to “native” protocol, the following protocol is used.

Protocol definition.

This protocol uses pipe (‘|’) delineated ASCII strings to translate “native” protocol to this generalizing protocol. The ASCII text is outlined as follows”.

Device ID|Type|OpCode|Command|Parameter 1|[|Parameter 2][| . . . ][|Parameter n]

Explanation:

Device ID This is the unit ID/device ID.

Type This is the type of command that will follow. ‘Command’ or ‘Request’.

OpCode This is the type of command that will follow. ‘pan’, ‘tilt’, ‘zoom’, ‘iris’.

Command This is dependant on the OpCode. ‘right’, ‘left’, ‘up’, ‘down’, ‘in’, ‘out’, ‘save’, “go”.

Parameter 1 This is an additional parameter that is dependant on the OpCode and Command. ‘1’, ‘2’, ‘3’, . . . ‘8’,

Parameter 2 This is an additional parameter that is dependant on the OpCode, Command, and Parameter 1.

An example of the translations follows:

‘Input’ protocol to ‘generic’ protocol.

Command: Device ID 1, Pan Left Normal Speed.

Input: 01 03 00 01 07 05 00 00 0F 82 01 00 00 f1 56

Output: 1|command|pan|left|45 (speed is indicated as degrees per second)

Command: Device ID 12, Shutter Speed 1/500

Input: 0C 03 00 01 07 0A 00 00 0F 8C 02 04 00 11 AD

Output: 12|command|shutter|maual|500 (speed is indicated as inverse of true speed.

E.g. 1/500=500 and 1/60=60)

‘Generic’ protocol to ‘Output’ protocol.

Command: Device ID 1, Pan Left Normal Speed.

Input: 1|command|pan|left|45 (speed is indicated as degrees per second)

Output: F8 01 ‘P’ ‘R’ 83

Command: Device ID 12, Shutter Speed 1/500

Input: 12|command|shutter|maual|500

Output: F8 0C ‘c’ ‘S’ 38 84

The invention described above is, of course, susceptible to many variations, modifications and changes, all of which are within the skill of the art. It should be understood that all such variations, modifications, and changes are within the spirit and scope of the invention and of the appended claims. Similarly, it will be understood that it is intended to cover all changes, modifications and variations of the example of the invention herein disclosed for the purpose of illustration which do not constitute departures from the spirit and scope of the present invention. The present invention is intended to be protected broadly within the spirit and scope of the appended claims.

What is claimed is:

1. A method for driving actuators for a pair of cameras which are remotely located from an operator and which form a portion of a motor vehicle highway monitoring system wherein each actuator operates only when it receives an input signal in its protocol or language which comprises:
a) sending an output signal to an actuator of said pair (the target actuator) in a first protocol or language wherein said actuator operates only when it receives an input signal in a language different from said first language and wherein said pair of actuators respectively respond to an input signal in a second or third language;
b) converting said output signal to a neutral protocol;
c) detecting the protocol used by the targeted actuator; and
d) converting the neutral protocol to the input protocol used by said targeted actuator.
e) whereby camera actuators using different protocols may be used in the same system.

2. A motor vehicle highway monitoring system having a pair of cameras which comprises:
a) a means for controlling the direction of the cameras which include an actuator responsive to an input signal;
b) means for sending an output signal in a first language to a user selected camera actuator (the target camera) where said actuator responds to an input signal which is in a language which is different from said output signal and wherein the camera actuates or may respond to input signals in different languages;
c) means for converting the output signal to a neutral language; and
d) means for converting said output in the neutral language to an input signal in the language of the targeted camera actuator.
e) whereby camera actuators using different protocols may be used in the same system.
